(19) United States
(12) Patent Application Publication
(10) Pub. No.: US 2024/0362754 A1
(43) Pub. Date: Oct. 31, 2024

(54) SYSTEMS AND METHODS FOR MOTION ARTIFACT SIMULATION

(71) Applicant: SHANGHAI UNITED IMAGING HEALTHCARE CO., LTD., Shanghai (CN)

(72) Inventor: Jiao TIAN, Shanghai (CN)

(73) Assignee: SHANGHAI UNITED IMAGING HEALTHCARE CO., LTD., Shanghai (CN)

(21) Appl. No.: 18/764,345

(22) Filed: Jul. 4, 2024

Related U.S. Application Data
(63) Continuation of application No. PCT/CN2023/079098, filed on Mar. 1, 2023.

(30) Foreign Application Priority Data
Mar. 1, 2022 (CN) 202210195616.3

(51) Int. Cl. G06T 5/60; G06T 5/50; G06T 7/30; G06T 7/60

(52) U.S. Cl. CPC G06T 5/60; G06T 5/50; G06T 7/30; G06T 7/60; G06T 2207/10081; G06T 2207/10088; G06T 2207/20081; G06T 2207/30004

(57) ABSTRACT

Systems and methods for motion artifact simulation are provided. The systems may obtain a target image including a target object. The systems may determine a plurality of sub-periods of a time period corresponding to the target image. The systems may determine a plurality of motion vector fields of the target object in the plurality of sub-periods. Each motion vector field of the plurality of motion vector fields may correspond to one of the plurality of sub-periods. The systems may determine a plurality of reconstruction images of the target object corresponding to the plurality of sub-periods based on projection data of the target image. Each reconstruction image of the plurality of reconstruction images may correspond to one of the plurality of sub-periods. The systems may generate a motion artifact simulation image of the target object based on the plurality of motion vector fields and the plurality of reconstruction images.

### CROSS-REFERENCE TO RELATED APPLICATIONS

This application is a continuation of International Application No. PCT/CN2023/079098, filed on Mar. 1, 2023, which claims priority to Chinese Patent Application No. 202210195616.3 filed on Mar. 1, 2022, the contents of each of which are incorporated herein by reference in their entirety.

### TECHNICAL FIELD

The present disclosure generally relates to image processing technology, and more particularly, relates to systems and methods for motion artifact simulation.

### BACKGROUND

Motion artifacts may appear in scanning images of an object in motion, which affects the imaging quality of the object, thereby affecting the diagnosis and treatment of the object. Taking the heart as an example, motion artifacts of the heart would affect the observation of a state of the heart. Generally, in order to reduce the motion artifacts in the scanning images of the object in motion, a motion artifact removal model may be used to correct the scanning images containing motion artifacts. However, a training of the motion artifact removal model requires a large number of images containing motion artifacts. Therefore, it is desirable to provide systems and methods for motion artifact simulation to obtain a large number of images containing motion artifacts.

### SUMMARY

An aspect of the present disclosure relates to a system for motion artifact simulation. The system may include at least one storage device including a set of instructions and at least one processor in communication with the at least one storage device. When executing the set of instructions, the at least one processor may be directed to cause the system to implement operations. The operations may include obtaining a target image including a target object; determining a plurality of sub-periods of a time period corresponding to the target image; determining a plurality of motion vector fields of the target object in the plurality of sub-periods, each motion vector field of the plurality of motion vector fields corresponding to one of the plurality of sub-periods; determining a plurality of reconstruction images of the target object corresponding to the plurality of sub-periods based on projection data of the target image, each reconstruction image of the plurality of reconstruction images corresponding to one of the plurality of sub-periods; and generating a motion artifact simulation image of the target object based on the plurality of motion vector fields and the plurality of reconstruction images.

In some embodiments, the target image has a quality score higher than a predetermined threshold.

In some embodiments, each motion vector field of the plurality of motion vector fields includes parameters associated with a motion state of the target object.

In some embodiments, the determining the plurality of motion vector fields of the target object in the plurality of sub-periods includes determining the plurality of motion vector fields of the target object in the plurality of sub-periods based on the target image, the plurality of sub-periods, and an artifact simulation model.

In some embodiments, the determining the plurality of motion vector fields of the target object in the plurality of sub-periods based on the target image, the plurality of sub-periods, and the artifact simulation model includes extracting a centerline of the target object in the target image; and determining the plurality of motion vector fields of the target object in the plurality of sub-periods based on the centerline of the target object in the target image, the plurality of sub-periods, and the artifact simulation model.

In some embodiments, the artifact simulation model includes a motion function or a machine learning model.

In some embodiments, the motion function includes a random function indicating the motion state of the target object.

In some embodiments, the machine learning model is configured to assign random values to at least a portion of the parameters of the motion vector field.

In some embodiments, the machine learning model is obtained by obtaining a plurality of training samples, each of the plurality of training samples including a sample target image of a sample target object and a plurality of sample artifact images of the sample target object; and determining the machine learning model by performing a plurality of iterative trainings on a preliminary machine learning model based on the plurality of training samples.

In some embodiments, the determining the machine learning model by performing the plurality of iterative trainings on the preliminary machine learning model includes in an iteration of an iterative training of the plurality of iterative trainings, determining an output image by inputting a training sample of the plurality of training samples into the preliminary machine learning model; determining whether a termination condition of the iterative training is satisfied by comparing the output image and a plurality of sample artifact images in the training sample; in response to that the termination condition of the iterative training is not satisfied, updating values of model parameters of the preliminary machine learning model and performing a next iteration of the iterative training on the preliminary machine learning model with the updated model parameters; in response to that the termination condition of the iterative training is satisfied, performing a next iterative training on the preliminary machine learning model based on another training sample of the plurality of training samples.

In some embodiments, the determining the plurality of reconstruction images of the target object corresponding to the plurality of sub-periods includes obtaining a plurality of projection data sets of the target image, each projection data set of the plurality of projection data sets corresponding to one of the plurality of sub-periods; and determining the plurality of reconstruction images of the target object corresponding to the plurality of sub-periods based on the plurality of projection data sets of the target image, respectively.

In some embodiments, the generating the motion artifact simulation image of the target object includes for a target sub-period of the plurality of sub-time periods, generating a motion compensation image based on at least one of the plurality of motion vector fields and at least one of the plurality of reconstruction images; and generating the motion artifact simulation image of the target object by superimposing a plurality of motion compensation images corresponding to the plurality of sub-time periods.

In some embodiments, the generating the motion compensation image based on the at least one of the plurality of motion vector fields and the at least one of the plurality of reconstruction images includes generating the motion compensation image based on the at least one of the plurality of motion vector fields, the at least one of the plurality of reconstruction images, and at least one of a plurality of weight curves, each of the plurality of weight curves corresponding to one of the plurality of sub-periods.

In some embodiments, the generating the motion compensation image based on the at least one of the plurality of motion vector fields, the at least one of the plurality of reconstruction images, and the at least one of the plurality of weight curves includes

In some embodiments, for each sub-period of the plurality of sub-periods, determining an intermediate image based on a motion vector field of the plurality of motion vector fields and a reconstruction image of the plurality of reconstruction images, the motion vector field and the reconstruction image corresponding to the each sub-period; and performing a weighted combination on at least two of a plurality of intermediate images corresponding to at least two of the plurality of sub-periods according to a target weight curve of the plurality of weight curves corresponding to the target sub-period.

In some embodiments, the motion artifact simulation image is configured to train a motion artifact removal model.

A further aspect of the present disclosure relates to a method for motion artifact simulation. The method may be implemented on a computing device including at least one processor, at least one storage medium, and a communication platform connected to a network. The method may include obtaining a target image including a target object; determining a plurality of sub-periods of a time period corresponding to the target image; determining a plurality of motion vector fields of the target object in the plurality of sub-periods, each motion vector field of the plurality of motion vector fields corresponding to one of the plurality of sub-periods; determining a plurality of reconstruction images of the target object corresponding to the plurality of sub-periods based on projection data of the target image, each reconstruction image of the plurality of reconstruction images corresponding to one of the plurality of sub-periods; and generating a motion artifact simulation image of the target object based on the plurality of motion vector fields and the plurality of reconstruction images.

A still further aspect of the present disclosure relates to a system for motion artifact simulation. The system may include an obtaining module, a first determination module, a second determination module, a third determination module, and a generation module. The obtaining module is configured to obtain a target image including a target object. The first determination module is configured to determine a plurality of sub-periods of a time period corresponding to the target image. The second determination module is configured to determine a plurality of motion vector fields of the target object in the plurality of sub-periods. Each motion vector field of the plurality of motion vector fields corresponds to one of the plurality of sub-periods. The third determination module is configured to determine a plurality of reconstruction images of the target object corresponding to the plurality of sub-periods based on projection data of the target image. Each reconstruction image of the plurality of reconstruction images corresponds to one of the plurality of sub-periods. The generation module is configured to generate a motion artifact simulation image of the target object based on the plurality of motion vector fields and the plurality of reconstruction images.

A still further aspect of the present disclosure relates to a non-transitory computer readable medium including executable instructions. When the executable instructions are executed by at least one processor, the executable instructions may direct the at least one processor to perform a method. The method may include obtaining a target image including a target object; determining a plurality of sub-periods of a time period corresponding to the target image; determining a plurality of motion vector fields of the target object in the plurality of sub-periods, each motion vector field of the plurality of motion vector fields corresponding to one of the plurality of sub-periods; determining a plurality of reconstruction images of the target object corresponding to the plurality of sub-periods based on projection data of the target image, each reconstruction image of the plurality of reconstruction images corresponding to one of the plurality of sub-periods; and generating a motion artifact simulation image of the target object based on the plurality of motion vector fields and the plurality of reconstruction images.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary motion artifact simulation system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing device according to some embodiments of the present disclosure;

FIG. 5 is a flowchart illustrating an exemplary process for motion artifact simulation according to some embodiments of the present disclosure;

FIGS. 6A-6B are schematic diagrams illustrating exemplary weight curves according to some embodiments of the present disclosure; and

FIG. 7 is a flowchart illustrating an exemplary process for determining an artifact simulation model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “unit,” “module,” and/or “block” used herein are one method to distinguish different components, elements, parts, sections, or assemblies of different levels in ascending order. However, the terms may be displaced by another expression if they achieve the same purpose.

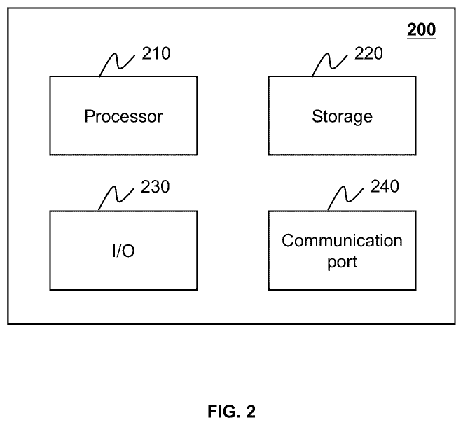

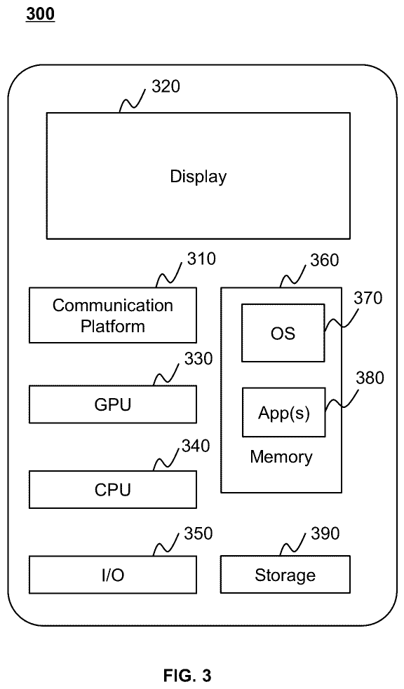

Generally, the words “module,” “unit,” or “block,” as used herein, refer to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 illustrated in FIG. 2 and/or the central processing unit (CPU) 340 illustrated in FIG. 3) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included in programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The term “image” in the present disclosure is used to collectively refer to image data (e.g., scan data, projection data) and/or images of various forms, including a two-dimensional (2D) image, a three-dimensional (3D) image, a four-dimensional (4D), etc. The term “pixel” and “voxel” in the present disclosure are used interchangeably to refer to an element of an image. The term “anatomical structure” in the present disclosure may refer to gas (e.g., air), liquid (e.g., water), solid (e.g., stone), cell, tissue, organ of a subject, or any combination thereof, which may be displayed in an image (e.g., a second image, or a first image, etc.) and really exist in or on the subject's body. The term “region,” “location,” and “area” in the present disclosure may refer to a location of an anatomical structure shown in the image or an actual location of the anatomical structure existing in or on the subject's body, since the image may indicate the actual location of a certain anatomical structure existing in or on the subject's body.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for motion artifact simulation. The systems may obtain a target image (e.g., a computed tomography (CT) image, a magnetic resonance (MR) image) including a target object (e.g., a coronary artery). The systems may determine a plurality of sub-periods of a time period associated with the target image. The systems may determine a plurality of motion vector fields of the target object in the plurality of sub-periods. Each motion vector field of the plurality of motion vector fields may correspond to one of the plurality of sub-periods. The systems may determine a plurality of reconstruction images of the target object corresponding to the plurality of sub-periods based on projection data of the target image. Each reconstruction image of the plurality of reconstruction images may correspond to one of the plurality of sub-periods. Further, the systems may generate a motion artifact simulation image of the target object based on the plurality of motion vector fields and the plurality of reconstruction images.

According to the systems and methods of the present disclosure, a large number of motion artifact simulation images (i.e., images containing motion artifacts) may be generated. The large number of motion artifact simulation images may be configured to train a motion artifact removal model, which may improve the performance of the trained motion artifact removal model. The trained motion artifact removal model may be configured to correct or reduce motion artifacts in scanning images of an object in motion, which may improve the imaging quality of the object in motion, thereby improving the accuracy of the diagnosis and treatment of the object.

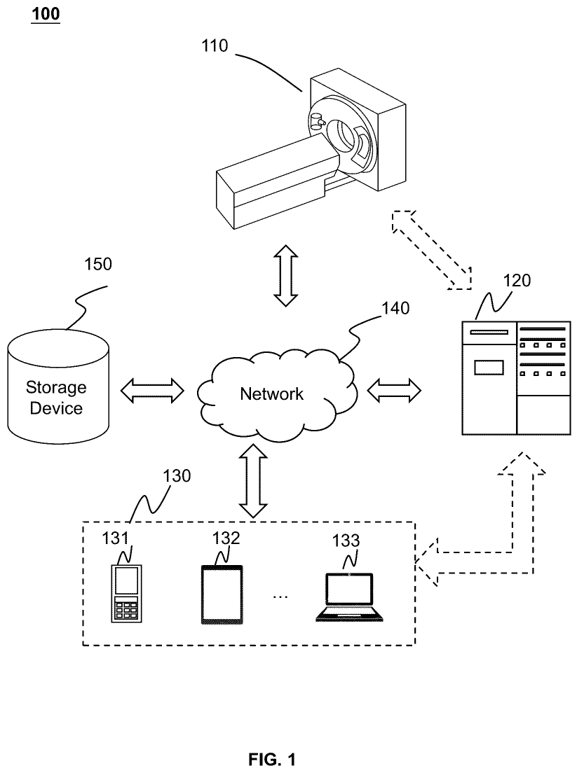

FIG. 1 is a schematic diagram illustrating an exemplary motion artifact simulation system according to some embodiments of the present disclosure. As illustrated in FIG. 1, the motion artifact simulation system 100 may include an imaging device 110, a processing device 120, a terminal device 130, a network 140, and a storage device 150. The components of the motion artifact simulation system 100 may be connected in one or more of various ways. Mere by way of example, as illustrated in FIG. 1, the imaging device 110 may be connected to the processing device 120 through the network 140. As another example, the imaging device 110 may be connected to the processing device 120 directly (as indicated by the bi-directional arrow in dotted lines linking the imaging device 110 and the processing device 120). As a further example, the storage device 150 may be connected to the processing device 120 directly or through the network 140. As still a further example, the terminal device 130 may be connected to the processing device 120 directly (as indicated by the bi-directional arrow in dotted lines linking the terminal device 130 and the processing device 120) or through the network 140.

The imaging device 110 may be configured to acquire image data relating to at least one part of a subject. The imaging device 110 may scan the subject or a portion thereof that is located within its detection region and generate image data relating to the subject or the portion thereof. The image data relating to at least one part of a subject may include one or more images, projection data, or a combination thereof. In some embodiments, the image data may be two-dimensional (2D) image data, three-dimensional (3D) image data, four-dimensional (4D) image data, or the like, or any combination thereof. In some embodiments, the imaging device 110 may include a single modality imaging device. For example, the imaging device 110 may include a digital subtraction angiography (DSA), a positron emission tomography (PET) device, a single-photon emission computed tomography (SPECT) device, a magnetic resonance imaging (MRI) device (also referred to as an MR device, an MR scanner), a computed tomography (CT) device, an ultrasonography scanner, a digital radiography (DR) scanner, or the like, or any combination thereof. In some embodiments, the imaging device 110 may include a multi-modality imaging device. Exemplary multi-modality imaging devices may include a PET-CT device, a PET-MR device, or the like, or a combination thereof.

The processing device 120 may process data and/or information obtained from the imaging device 110, the terminal device 130, and/or the storage device 150. For example, the processing device 120 may obtain one or more images captured by the imaging device 110 and determine a target image from the one or more images. The processing device 120 may determine a plurality of sub-periods of a time period associated with the target image. Further, the processing device 120 may determine a plurality of motion vector fields of the target object in the plurality of sub-periods and a plurality of reconstruction images of the target object corresponding to the plurality of sub-periods. According to the plurality of motion vector fields and the plurality of reconstruction images, the processing device 120 may generate a motion artifact simulation image of the target object.

In some embodiments, the processing device 120 may include a central processing unit (CPU), a digital signal processor (DSP), a system on a chip (SoC), a microcontroller unit (MCU), or the like, or any combination thereof. In some embodiments, the processing device 120 may include a computer, a user console, a single server or a server group, etc. The server group may be centralized or distributed. In some embodiments, the processing device 120 may be local or remote. For example, the processing device 120 may access information and/or data stored in the imaging device 110, the terminal device 130, and/or the storage device 150 via the network 140. As another example, the processing device 120 may be directly connected to the imaging device 110, the terminal device 130, and/or the storage device 150 to access stored information and/or data. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 120 or a portion of the processing device 120 may be integrated into the imaging device 110. In some embodiments, the processing device 120 may be implemented by a computing device 200 including one or more components as described in FIG. 2.

The terminal device 130 may enable interaction between the user and other components (e.g., the imaging device 110, the processing device 120, the storage device 150) of the motion artifact simulation system 100. In some embodiments, the terminal device 130 may connect and/or communicate with the other components (e.g., the imaging device 110, the processing device 120, the storage device 150) of the motion artifact simulation system 100. For example, the terminal device 130 may obtain, from the processing device 120, a processing result, e.g., the generated motion artifact simulation image. As another example, the terminal device 130 may display the processing result obtained from the processing device 120. As a further example, the user (e.g., a doctor, a radiologist) may send one or more instructions to the imaging device 110 through the terminal device 130 to control the imaging device 110 to scan the subject or a portion thereof according to the instructions. In some embodiments, the terminal device 130 may include a mobile device 131, a tablet computer 132, a laptop computer 133, or the like, or any combination thereof. In some embodiments, the terminal device 130 may be part of the processing device 120. In some embodiments, the terminal device 130 may be implemented by a mobile device 300 including one or more components as described in FIG. 3.

The network 140 may facilitate exchange of information and/or data. In some embodiments, the network 140 may be any type of wired or wireless network, or a combination thereof. Merely by way of example, the network 140 may include a hospital information system (HIS), a picture archiving and communication system (PACS), or other networks connected thereto although independent of the HIS or PACS. In some embodiments, one or more components (e.g., the imaging device 110, the processing device 120, the storage device 150, the terminal device 130) of the motion artifact simulation system 100 may communicate information and/or data with one or more other components of the motion artifact simulation system 100 via the network 140. For example, the processing device 120 may obtain, via the network 140, the imaging data relating to the subject or a portion thereof from the imaging device 110. As another example, the processing device 120 may obtain an instruction of a user (e.g., a doctor, a radiologist) from the terminal device 130 via the network 140. In some embodiments, one or more components (e.g., the imaging device 110, the processing device 120, the storage device 150, the terminal device 130) of the motion artifact simulation system 100 may communicate information and/or data with one or more external resources such as an external database of a third party, etc. For example, the processing device 120 may obtain an artifact simulation model (e.g., a trained machine learning model) from a database of a vendor or manufacture (e.g., a manufacture of the imaging device 110) that provides and/or updates the artifact simulation model.

The storage device 150 may store data (e.g., the target image, the motion artifact simulation image, the artifact simulation model), instructions, and/or any other information. In some embodiments, the storage device 150 may store data obtained from the imaging device 110, the terminal device 130, and/or the processing device 120. In some embodiments, the storage device 150 may store data and/or instructions that the processing device 120 may execute or use to perform exemplary methods described in the present disclosure. In some embodiments, the storage device 150 may include a mass storage device, a removable storage device, a volatile read-and-write memory, a read-only memory (ROM), or the like, or a combination thereof. In some embodiments, the storage device 150 may be implemented on a cloud platform as described elsewhere in the disclosure.

In some embodiments, the storage device 150 may be connected to the network 140 to communicate with one or more components (e.g., the imaging device 110, the processing device 120, the terminal device 130) of the motion artifact simulation system 100. One or more components of the motion artifact simulation system 100 may access the data or instructions stored in the storage device 150 via the network 140. In some embodiments, the storage device 150 may be directly connected to or communicate with one or more components of the motion artifact simulation system 100. In some embodiments, the storage device 150 may be part of the imaging device 110, the processing device 120, or the terminal device 130.

It should be noted that the above description of the motion artifact simulation system 100 is merely provided for the purposes of illustration, and not intended to limit the scope of the present disclosure. For persons having ordinary skills in the art, multiple variations and modifications may be made under the teachings of the present disclosure. For example, the motion artifact simulation system 100 may include one or more additional components and/or one or more components of the motion artifact simulation system 100 described above may be omitted. Additionally or alternatively, two or more components of the motion artifact simulation system 100 may be integrated into a single component. A component of the motion artifact simulation system 100 may be implemented on two or more sub-components. However, those variations and modifications do not depart from the scope of the present disclosure.

FIG. 2 is a schematic diagram illustrating exemplary hardware and/or software components of an exemplary computing device according to some embodiments of the present disclosure. The computing device 200 may be used to implement any component of the motion artifact simulation system 100 as described herein. For example, the processing device 120 and/or the terminal device 130 may be implemented on the computing device 200, respectively, via its hardware, software program, firmware, or a combination thereof. Although only one such computing device is shown, for convenience, the computer functions relating to the motion artifact simulation system 100 as described herein may be implemented in a distributed fashion on a number of similar platforms, to distribute the processing load. As illustrated in FIG. 2, the computing device 200 may include a processor 210, a storage 220, an input/output (I/O) 230, and a communication port 240.

The processor 210 may execute computer instructions (e.g., program codes) and perform functions of the processing device 120 in accordance with techniques described herein. The computer instructions may include, for example, routines, programs, objects, components, data structures, procedures, modules, and functions, which perform particular functions described herein. For example, the processor 210 may process data obtained from the imaging device 110, the storage device 150, the terminal device 130, and/or any other components of the motion artifact simulation system 100. For example, the processor 210 may obtain one or more images captured by the imaging device 110 and determine a target image from the one or more images. The processor 210 may determine a plurality of sub-periods of a time period associated with the target image. Further, the processor 210 may determine a plurality of motion vector fields of the target object in the plurality of sub-periods and a plurality of reconstruction images of the target object corresponding to the plurality of sub-periods. According to the plurality of motion vector fields and the plurality of reconstruction images, the processor 210 may generate a motion artifact simulation image of the target object.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the imaging device 110, the storage device 150, the terminal device 130, and/or any other component of the motion artifact simulation system 100. In some embodiments, the storage 220 may include a mass storage device, a removable storage device, a volatile read-and-write memory, a read-only memory (ROM), or the like, or a combination thereof. In some embodiments, the storage 220 may store one or more programs and/or instructions to perform exemplary methods described in the present disclosure.

The I/O 230 may input and/or output signals, data, information, etc. In some embodiments, the I/O 230 may enable user interaction with the processing device 120. In some embodiments, the I/O 230 may include an input device and an output device. The input device may include alphanumeric and other keys that may be input via a keyboard, a touch screen (for example, with haptics or tactile feedback), a speech input, an eye-tracking input, a brain monitoring system, or any other comparable input mechanism. The input information received through the input device may be transmitted to another component (e.g., the processing device 120) via, for example, a bus, for further processing. Other types of the input device may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 140) to facilitate data communications. The communication port 240 may establish connections between the processing device 120 and one or more components (e.g., the imaging device 110, the storage device 150, and/or the terminal device 130) of the motion artifact simulation system 100. The connection may be a wired connection, a wireless connection, any other communication connection that can enable data transmission and/or reception, and/or a combination of these connections.

FIG. 3 is a schematic diagram illustrating exemplary hardware and/or software components of an exemplary mobile device according to some embodiments of the present disclosure. In some embodiments, one or more components (e.g., the terminal device 130, the processing device 120) of the motion artifact simulation system 100 may be implemented on one or more components of the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the motion artifact simulation system 100. User interactions with the information stream may be achieved via the I/O 350 and provided to the processing device 120 and/or other components of the motion artifact simulation system 100 via the network 140.

To implement various modules, units, and their functionalities described in the present disclosure, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to generate an image as described herein. A computer with user interface elements may be used to implement a personal computer (PC) or another type of work station or terminal device, although a computer may also act as a server if appropriately programmed. It is believed that those skilled in the art are familiar with the structure, programming, and general operation of such computer equipment and as a result, the drawings should be self-explanatory.

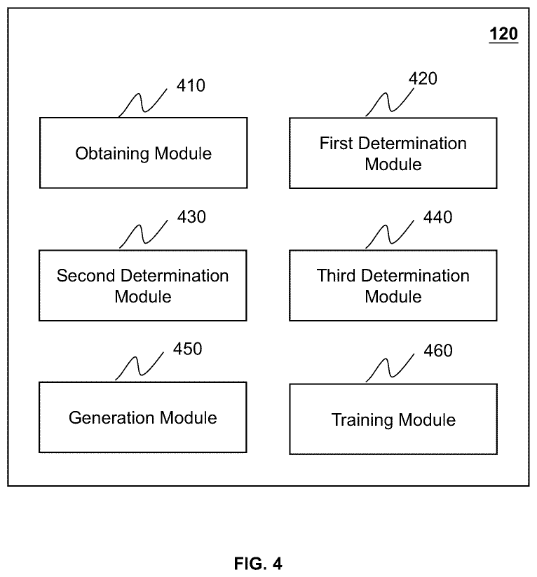

FIG. 4 is a block diagram illustrating an exemplary processing device according to some embodiments of the present disclosure. The processing device 120 may be implemented on the computing device 200 (e.g., the processor 210) illustrated in FIG. 2 or the mobile device 300 illustrated in FIG. 3. The processing device 120 may include an obtaining module 410, a first determination module 420, a second determination module 430, a third determination module 440, a generation module 450, and a training module 460.

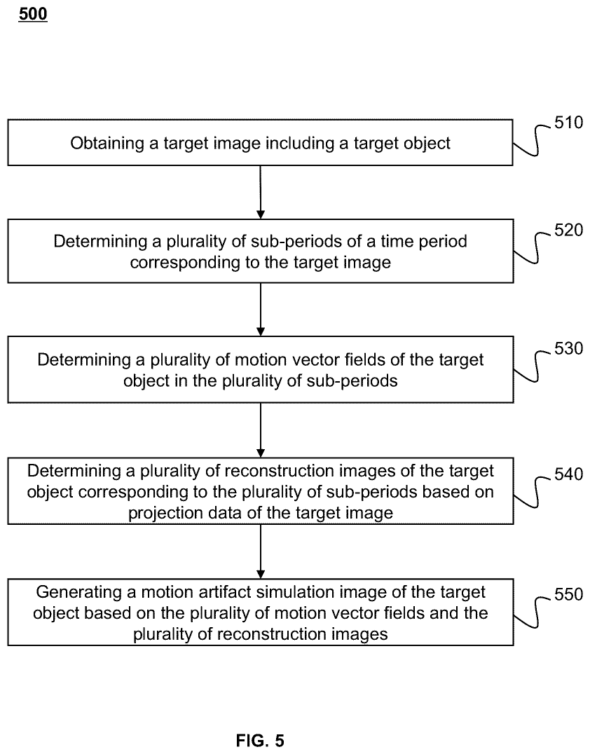

The obtaining module 410 may be configured to obtain a target image including a target object. The target image may have a quality score higher than a predetermined threshold. More descriptions regarding the target image and/or the obtaining of the target image may be found elsewhere in the present disclosure (e.g., operation 510 in FIG. 5 and the description thereof).

The first determination module 420 may be configured to determine a plurality of sub-periods of a time period corresponding to the target image. More descriptions regarding the plurality of sub-periods, the time period, and/or the determination of the plurality of sub-periods may be found elsewhere in the present disclosure (e.g., operation 520 in FIG. 5 and the description thereof).

The second determination module 430 may be configured to determine a plurality of motion vector fields of the target object in the plurality of sub-periods. Each motion vector field of the plurality of motion vector fields may include parameters associated with a motion state of the target object. In some embodiments, the second determination module 430 may be configured to determine the plurality of motion vector fields of the target object in the plurality of sub-periods based on the target image, the plurality of sub-periods, and an artifact simulation model. In some embodiments, the second determination module 430 may be configured to extract a centerline of the target object in the target image and determine the plurality of motion vector fields of the target object in the plurality of sub-periods based on the centerline of the target object in the target image, the plurality of sub-periods, and the artifact simulation model. In some embodiments, the artifact simulation model may include a motion function or a machine learning model. In some embodiments, the motion function may include a random function indicating the motion state of the target object. In some embodiments, the machine learning model may be configured to assign random values to at least a portion of the parameters of the motion vector field. More descriptions regarding the plurality of motion vector fields and/or the determination of the plurality of motion vector fields may be found elsewhere in the present disclosure (e.g., operation 530 in FIG. 5 and the description thereof).

The third determination module 440 may be configured to determine a plurality of reconstruction images of the target object corresponding to the plurality of sub-periods based on projection data of the target image. In some embodiments, the third determination module 440 may be configured to obtain a plurality of projection data sets of the target image. Each projection data set of the plurality of projection data sets may correspond to one of the plurality of sub-periods. Further, the third determination module 440 may be configured to determine the plurality of reconstruction images of the target object corresponding to the plurality of sub-periods based on the plurality of projection data sets of the target image, respectively. More descriptions regarding the plurality of reconstruction images and/or the determination of the plurality of reconstruction images may be found elsewhere in the present disclosure (e.g., operation 540 in FIG. 5 and the description thereof).

The generation module 450 may be configured to generate a motion artifact simulation image of the target object based on the plurality of motion vector fields and the plurality of reconstruction images. In some embodiments, the generation module 450 may be configured to, for a target sub-period of the plurality of sub-time periods, generate a motion compensation image based on at least one of the plurality of motion vector fields and at least one of the plurality of reconstruction images. In some embodiments, the generation module 450 may be configured to generate the motion compensation image based on the at least one of the plurality of motion vector fields, the at least one of the plurality of reconstruction images, and at least one of a plurality of weight curves. Each of the plurality of weight curves may correspond to one of the plurality of sub-periods. In some embodiments, the generation module 450 may be configured to, for each sub-period of the plurality of sub-periods, determine an intermediate image based on a motion vector field of the plurality of motion vector fields and a reconstruction image of the plurality of reconstruction images. The motion vector field and the reconstruction image may correspond to the each sub-period. The generation module 450 may be configured to perform a weighted combination on at least two of a plurality of intermediate images corresponding to at least two of the plurality of sub-periods according to a target weight curve of the plurality of weight curves corresponding to the target sub-period. Further, the generation module 450 may be configured to generate the motion artifact simulation image of the target object by superimposing a plurality of motion compensation images corresponding to the plurality of sub-time periods. In some embodiments, the motion artifact simulation image may be configured to train a motion artifact removal model. More descriptions regarding the motion artifact simulation image and/or the generation of the motion artifact simulation image may be found elsewhere in the present disclosure (e.g., operation 550 in FIG. 5 and the description thereof).

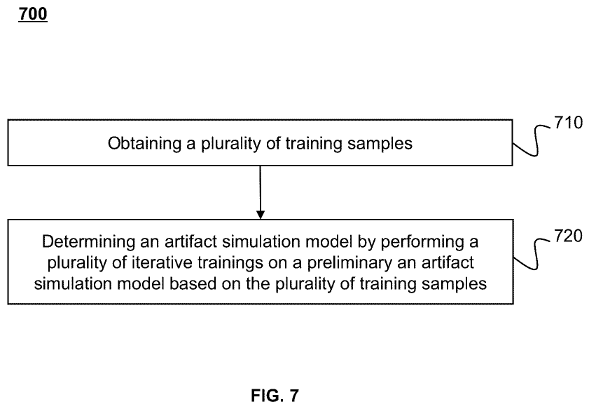

The training module 460 may be configured to obtain the machine learning model. In some embodiments, the training module 460 may be configured to obtain a plurality of training samples. Each of the plurality of training samples may include a sample target image of a sample target object and a plurality of sample artifact images of the sample target object. Further, the training module 460 may be configured to determine the machine learning model by performing a plurality of iterative trainings on a preliminary machine learning model based on the plurality of training samples. In some embodiments, the training module 460 may be configured to, in an iteration of an iterative training of the plurality of iterative trainings, determine an output image by inputting a training sample of the plurality of training samples into the preliminary machine learning model and determine whether a termination condition of the iterative training is satisfied by comparing the output image and a plurality of sample artifact images in the training sample. In response to that the termination condition of the iterative training is not satisfied, the training module 460 may be configured to update values of model parameters of the preliminary machine learning model and perform a next iteration of the iterative training on the preliminary machine learning model with the updated model parameters. In response to that the termination condition of the iterative training is satisfied, the training module 460 may be configured to perform a next iterative training on the preliminary machine learning model based on another training sample of the plurality of training samples. More descriptions regarding the machine learning model and/or the obtaining of the machine learning model may be found elsewhere in the present disclosure (e.g., FIG. 5, FIG. 7, and the description thereof).

It should be noted that the modules illustrated in FIG. 4 may be implemented via various ways. For example, the modules may be implemented through hardware, software, or a combination thereof. Herein, the hardware may be implemented by a dedicated logic; the software may be stored in the storage and be executed by proper instructions, for example, by a microprocessor or a dedicated design hardware. Those skilled in the art may understand that, the methods and systems described in the present disclosure may be implemented by the executable instructions of a computer and/or by control code in the processor, for example, the code supplied in a carrier medium such as a disk, a CD, a DVD-ROM, in a programmable storage such as a read-only memory, or in a data carrier such as optical signal carrier or electric signal carrier. The systems and the methods in the present disclosure may be implemented by a hardware circuit in a programmable hardware device in an ultra-large scale integrated circuit, a gate array chip, a semiconductor such as a transistor, a field programmable gate array, a programmable logic device, a software performed by various processors, or a combination thereof (e.g., firmware).

It should be noted that the above description regarding the processing device 120 is merely provided for the purposes of illustration, and not intended to limit the scope of the present disclosure. For persons having ordinary skills in the art, multiple variations and modifications may be made under the teachings of the present disclosure. In some embodiments, two or more of the modules may be combined into a single module, and any one of the modules may be divided into two or more units. For example, at least two of the first determination module 420, the second determination module 430, and the third determination module 440 may be combined as a single module. In some embodiments, the processing device 120 may include one or more additional modules. For example, the processing device 120 may also include a transmission module (not shown) configured to transmit signals (e.g., electrical signals, electromagnetic signals) to one or more components (e.g., the imaging device 110, the terminal device 130, the storage device 150) of the motion artifact simulation system 100. As another example, the processing device 120 may include a storage module (not shown) used to store information and/or data (e.g., the target image, the motion artifact simulation image, the artifact simulation model) associated with the motion artifact simulation. In some embodiments, the training module 460 may be implemented on a separate device (e.g., a processing device independent from the processing device 120). In some embodiments, the training module 460 may be unnecessary and the artifact simulation model may be obtained from a storage device (e.g., the storage device 150, the storage 220, and/or the storage 390) disclosed elsewhere in the present disclosure and/or an external storage device. However, those variations and modifications do not depart from the scope of the present disclosure.

FIG. 5 is a flowchart illustrating an exemplary process for motion artifact simulation according to some embodiments of the present disclosure. In some embodiments, process 500 may be executed by the motion artifact simulation system 100. For example, the process 500 may be implemented as a set of instructions (e.g., an application) stored in a storage device (e.g., the storage device 150, the storage 220, and/or the storage 390) disclosed elsewhere in the present disclosure and/or an external storage device. In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 500.

In 510, the processing device 120 (e.g., the obtaining module 410) (e.g., the interface circuits and/or the processing circuits of the processor 210) may obtain a target image including a target object.

The target image may refer to an image that has a quality score higher than a predetermined threshold. The predetermined threshold may be determined based on a default value of the motion artifact simulation system 100, manually set by a user (e.g., a doctor, a radiologist) or an operator, or determined by the processing device 120 according to an actual need.

In some embodiments, the processing device 120 may determine the target image from a plurality of initial images of an object. In some embodiments, the object may include a biological object and/or a non-biological object. The biological object may be a human being (e.g., a patient), an animal, a plant, or a specific portion, organ, and/or tissue thereof. For example, the tissue may include epithelial tissue, connective tissue, muscle tissue, neural tissue, soft tissue, or the like, or any combination thereof. As another example, the organ may include heart, liver, spleen, lung, stomach, or the like, or any combination thereof. In some embodiments, the object may be a man-made composition of organic and/or inorganic matters that are with or without life. In the present disclosure, the term “object” or “subject” are used interchangeably in the present disclosure. An initial image may refer to a medical image of the object.

In some embodiments, the processing device 120 may obtain the plurality of initial images of the object by directing or causing the imaging device 110 to perform a scan (e.g., an MR scan, a CT scan) on the object. In some embodiments, the plurality of initial images of the object may be previously determined and stored in a storage device (e.g., the storage device 150, the storage 220, and/or the storage 390) disclosed elsewhere in the present disclosure and/or an external storage device. The processing device 120 may obtain the plurality of initial images of the object from the storage device and/or the external storage device via a network (e.g., the network 140).

In some embodiments, the object may be or include the target object. The target object or a portion thereof may be in motion during imaging. For example, the target object may include tissues and/or organs (e.g., heart and lungs) in motion (e.g., respiration, heartbeat) during imaging. Due to the motion of the target object, artifacts (also referred to as motion artifacts) may occur in a medical image (e.g., an initial image) obtained by the imaging. In some embodiments, the target object may include tubular structures, for example, blood vessels (e.g., coronary arteries), and respiratory tracts, accordingly, the target image may include the tubular structures. Merely by way of example, the target image may be an image of the coronary arteries of the heart.

In some embodiments, a quality score of an image (e.g., an initial image) may be determined based on at least one of artifacts (e.g., motion artifacts), noise(s), or CT value(s) in the image. For example, for each of the plurality of initial images, the user (e.g., the doctor, the radiologist) may score the initial image based on the artifacts, the noise(s), and/or the CT value(s) in the initial image. Merely by way of example, the user may determine a quality of the initial image based on the artifact(s), the noise(s), and/or the CT value(s) in the initial image, and score the initial image based on the impact of the quality of the initial image on diagnosis of the object. In some embodiments, the plurality of initial images may be scored on a scale of 0-5 points. For example, an initial image with a quality (e.g., the initial image does not include motion artifacts) very suitable for diagnosis may be scored as 4-5 points; an initial image with a quality barely suitable for diagnosis may be scored as 3 points; an initial image with a quality uncertainly suitable for diagnosis may be scored as 2 points; an initial image with a quality not suitable for diagnosis may be scored as 1 point. Further, the processing device 120 may select the target image from the plurality of initial images based on quality scores of the plurality of initial images. For example, the processing device 120 may select an initial image with a quality score greater than or equal to a preset threshold (e.g., 3 points) as the target image.

In 520, the processing device 120 (e.g., the first determination module 420) (e.g., the processing circuits of the processor 210) may determine a plurality of sub-periods of a time period corresponding to the target image.

The time period may be determined based on a default value of the motion artifact simulation system 100, manually set by a user (e.g., a doctor, a radiologist) or an operator, or determined by the processing device 120 according to an actual need. In some embodiments, the time period may be a time period or a portion thereof associated with the obtaining of the target image. For example, the time period may be a time duration for obtaining imaging data of the target image by scanning the target object from 0 to 180 degrees. In some embodiments, the time period may be associated with a time phase of the target image. A physiological cycle of the target object may be divided into a plurality of time phases. For example, each physiological cycle of the heart usually includes eight time phases including isovolumic contraction, rapid ejection, slow ejection, prediastole, isovolumic relaxation, rapid filling, slow filling, and atrial systole. When the target image is obtained (or the target object is imaged), the heart may be in at least one of the above eight time phases. One of the at least one of the above eight time phases may be designated as the time phase of the target image. For example, the heart is in the isovolumic contraction when the target image is obtained, the isovolumic contraction may be designated as the time phase of the target image. As another example, the heart is in the isovolumic contraction and the rapid ejection when the target image is obtained, one of the isovolumic contraction and the rapid ejection may be designated as the time phase of the target image. In some embodiments, a central time point of the time period may be a central time point of the time phase of the target image.

In some embodiments, the processing device 120 may determine the plurality of sub-periods by dividing (evenly or unevenly) the time period based on a preset count of time nodes. In some embodiments, the preset count may be a default value (e.g., 5, 10, 20, 50, 100, 1000) of the motion artifact simulation system 100, manually set by a user (e.g., a doctor, a radiologist) or an operator, or determined by the processing device 120 according to an actual need. For example, the preset count of time nodes may be 5, for example, including TO corresponding to 0 degrees associated with the obtaining the imaging data of the target image (i.e., a time point when the obtaining of the imaging data of the target image starts), T1 corresponding to 45 degrees associated with the obtaining the imaging data of the target image, T2 corresponding to 90 degrees associated with the obtaining the imaging data of the target image, T3 corresponding to 135 degrees associated with the obtaining the imaging data of the target image, and T4 corresponding to 180 degrees associated with the obtaining the imaging data of the target image (i.e., a time point when the obtaining of the imaging data of the target image ends). Accordingly, the time period may be divided into 4 sub-periods including T0-T1, T1-T2, T2-T3, and T3-T4. In some embodiments, the time period may be independent of or irrelevant to the target image.

In 530, the processing device 120 (e.g., the second determination module 430) (e.g., the processing circuits of the processor 210) may determine a plurality of motion vector fields of the target object in the plurality of sub-periods.

Each motion vector field of the plurality of motion vector fields may correspond to one of the plurality of sub-periods. For example, the processing device 120 may determine 4 motion vector fields of the target object corresponding respectively to sub-periods T0-T1, T1-T2, T2-T3, and T3-T4. A motion vector field may indicate a motion state of the target object. In some embodiments, each motion vector field of the plurality of motion vector fields may include parameters associated with the motion state of the target object. In some embodiments, the parameters associated with the motion state of the target object may include coordinates, a motion direction, a motion speed, a motion time, a motion distance, a motion rate, a motion vector, or the like, or any combination thereof, of each pixel and/or voxel of the target image.

In some embodiments, the processing device 120 may determine the plurality of motion vector fields of the target object in the plurality of sub-periods based on the target image, the plurality of sub-periods, and an artifact simulation model. In some embodiments, the processing device 120 may extract a centerline of the target object in the target image and determine the plurality of motion vector fields of the target object in the plurality of sub-periods based on the centerline of the target object in the target image, the plurality of sub-periods, and the artifact simulation model. The centerline of the target object (also referred to as a target centerline) may refer to a geometric centerline of the target object along an extension direction of the target object. As used herein, the extension direction of an object may refer to a direction along the length of the object. The geometric centerline may include center points (e.g., pixels, voxels) of cross sections of the target object perpendicular to the extension direction of the target object. Merely by way of example, the target object may be a coronary artery, and the centerline of the target object may be a centerline (e.g., a geometric centerline) of the coronary artery. The motion of the centerline of the coronary artery may indicate the motion of the entire coronary artery, so that the motion vector fields determined based on the centerline of the coronary artery may indicate the motion of the entire coronary artery. Accordingly, the motion artifact simulation image generated based on the motion vector fields may indicate the actual motion of the coronary artery.

In some embodiments, the processing device 120 may extract the centerline of the target object in the target image by a centerline extraction algorithm. Merely by way of example, the centerline extraction algorithm may include a manual centerline extraction algorithm, a minimum path-based centerline extraction algorithm, an active contour model-based centerline extraction algorithm, or the like, or any combination thereof.

The artifact simulation model may be configured to simulate the motion artifacts of the target object. In some embodiments, the artifact simulation model may include a motion function or a machine learning model.

In some embodiments, the motion function may indicate the motion state of the target object. In some embodiments, the motion function may include a random function. Merely by way of example, the processing device 120 may determine the motion function as:

rate*(vec_x,vec_y,vec_z), (1)

where rate refers to a motion rate of a pixel and/or voxel of the target image, x, y, z refer to coordinates of the pixel and/or voxel of the target image, vec_x refers to a motion vector, along an x-coordinate direction, of the pixel and/or voxel of the target image, vec_y refers to a motion vector, along a y-coordinate direction, of the pixel and/or voxel of the target image, and vec_z refers to a motion vector, along a z-coordinate direction, of the pixel and/or voxel of the target image. In some embodiments, vec_x, vec_y, and/or vec_z may be randomly generated. In some embodiments, the random function may include a uniform motion function and/or a variable speed motion function. If the random function is the uniform motion function, rate in the motion function may be a constant value. If the random function is the variable speed motion function, rate in the motion function may be a randomly changing value.

The machine learning model may be configured to assign random values to the at least a portion (e.g., the motion direction, the motion speed, the motion distance, the motion rate, the motion vector) of the parameters of the motion vector field. In some embodiments, the machine learning model may be pre-trained and stored in a storage device (e.g., the storage device 150, the storage 220, and/or the storage 390) disclosed elsewhere in the present disclosure and/or an external storage device. The processing device 120 may retrieve the machine learning model from the storage device and/or the external storage device. In some embodiments, the machine learning model may include a neural network model or a deep learning model, etc. Merely by way of example, the neural network model may include a convolutional neural network (CNN), a fully convolutional neural network (FCN), a recursive Neural network (RNN)), a feedforward neural network (FNN), a recurrent neural network (RNN), a long and short-term memory neural network (LSTM), or the like, or any combination thereof. In some embodiments, the processing device 120 may input the target image and the plurality of sub-periods into the machine learning model. Respond to the input, the machine learning model may output the plurality of motion vector fields of the target object in the plurality of sub-periods. In some embodiments, the processing device 120 may input the centerline of the target object in the target image and the plurality of sub-periods into the machine learning model, and then determine the plurality of motion vector fields of the target object in the plurality of sub-periods based on an output of the machine learning model.

In some embodiments, the processing device 120 (e.g., the training module 460) (e.g., the processing circuits of the processor 210) may train the machine learning model based on a plurality of training samples online or offline and store the trained machine learning model in a storage device (e.g., the storage device 150, the storage 220, and/or the storage 390) disclosed elsewhere in the present disclosure and/or an external storage device. The processing device 120 may obtain the machine learning model from the storage device and/or the external storage device to apply the machine learning model for determining the plurality of motion vector fields. More descriptions regarding the training of the machine learning model may be found elsewhere in the present disclosure (e.g., FIG. 7 and the description thereof).

In 540, the processing device 120 (e.g., the third determination module 440) (e.g., the processing circuits of the processor 210) may determine a plurality of reconstruction images of the target object corresponding to the plurality of sub-periods based on projection data of the target image.

Each reconstruction image of the plurality of reconstruction images may correspond to one of the plurality of sub-periods. For example, the processing device 120 may determine 4 reconstruction images of the target object corresponding respectively to sub-periods T0-T1, T1-T2, T2-T3, and T3-T4.

In some embodiments, the processing device 120 may obtain a plurality of projection data sets of the target image. Each projection data set of the plurality of projection data sets may correspond to one of the plurality of sub-periods. In some embodiments, the processing device 120 may obtain the plurality of projection data sets of the target image by dividing projection data of the target image based on a scanning angle range of the target image. For example, the scanning angle range of the target image is 0-360 degrees. The processing device 120 may divide the projection data of the target image into 4 projection data sets corresponding to 0-90 degrees, 91-180 degrees, 181-270 degrees, and 271-360 degrees, respectively. As another example, the scanning angle range of the target image is 0-240 degrees. The processing device 120 may divide the projection data of the target image into 4 projection data sets corresponding to 0-60 degrees, 61-120 degrees, 121-180 degrees, and 181-240 degrees, respectively.

Further, the processing device 120 may determine the plurality of reconstruction images of the target object corresponding to the plurality of sub-periods based on the plurality of projection data sets of the target image, respectively. For example, for each of the plurality of sub-periods, the processing device 120 may determine a reconstruction image of the target object corresponding to the sub-period by performing reconstruction, using a reconstruction algorithm, on the projection data set corresponding to the sub-period. An exemplary reconstruction algorithm may include a back projection (BP) algorithm, a filtered back projection (FBP) algorithm, or the like, or any combination thereof. In some embodiments, for each of the plurality of sub-periods, the processing device 120 may determine a reconstruction image of the target object corresponding to the sub-period by performing reconstruction, using the reconstruction algorithm, on the projection data set corresponding to the sub-period and at least one of other projection data set corresponding to other sub-periods. For example, for a sub-period corresponding to the 61-120 degrees, the processing device 120 may determine a reconstruction image of the target object corresponding to the 61-120 degrees by performing reconstruction, using the reconstruction algorithm, on a projection data set corresponding to the 61-120 degrees and at least one of projection data sets corresponding to the 0-60 degrees, the 121-180 degrees, or 181-240 degrees.

In some embodiments, the processing device 120 may obtain projection data of other images by taking the scanning angle range of the target image as a center. For example, when the scanning angle range of the target image is 121-240 degrees, the processing device 120 may obtain the projection data of other images corresponding to 0-120 degrees and 241-360 degrees. As another example, when the scanning angle range of the target image is 91-180 degrees, the processing device 120 may obtain the projection data of other images corresponding to 0-90 degrees and 181-270 degrees. Further, the processing device 120 may determine the plurality of reconstruction images of the target object based on the projection data of the target image and the projection data of other images. For example, the processing device 120 may determine the plurality of reconstruction images of the target object based on the projection data of the target image corresponding to the 121-240 degrees and the projection data of other images corresponding to 0-120 degrees and 241-360 degrees. As another example, the processing device 120 may determine the plurality of reconstruction images of the target object based on the projection data of the target image corresponding to the 91-180 degrees and the projection data of other images corresponding to 0-90 degrees and 181-270 degrees.

In 550, the processing device 120 (e.g., the generation module 450) (e.g., the processing circuits of the processor 210) may generate a motion artifact simulation image of the target object based on the plurality of motion vector fields and the plurality of reconstruction images.

In some embodiments, for a target sub-period of the plurality of sub-time periods, the processing device 120 may generate a motion compensation image based on at least one of the plurality of motion vector fields and at least one of the plurality of reconstruction images. For example, the processing device 120 may generate the motion compensation image corresponding to the target sub-period based on a motion vector field of the plurality of motion vector fields corresponding to the target sub-period and a reconstruction image of the plurality of reconstruction images corresponding to the target sub-period. Specifically, for each of pixels and/or voxels in the reconstruction image corresponding to the target sub-period, the processing device 120 may generate the motion compensation image corresponding to the target sub-period by moving (i.e., elongating or distorting the reconstruction image corresponding to the target sub-period) coordinates of the pixel and/or voxel based on the motion vector field corresponding to the target sub-period.

As another example, the processing device 120 may generate the motion compensation image based on the at least one of the plurality of motion vector fields, the at least one of the plurality of reconstruction images, and at least one of a plurality of weight curves. Each of the plurality of weight curves may correspond to one of the plurality of sub-periods. In some embodiments, the plurality of weight curves may be a default setting of the motion artifact simulation system 100, manually set by a user (e.g., a doctor, a radiologist) or an operator, or determined by the processing device 120 according to an actual need. In some embodiments, a weight curve may be a straight line, a curve, or the like, or any combination thereof.

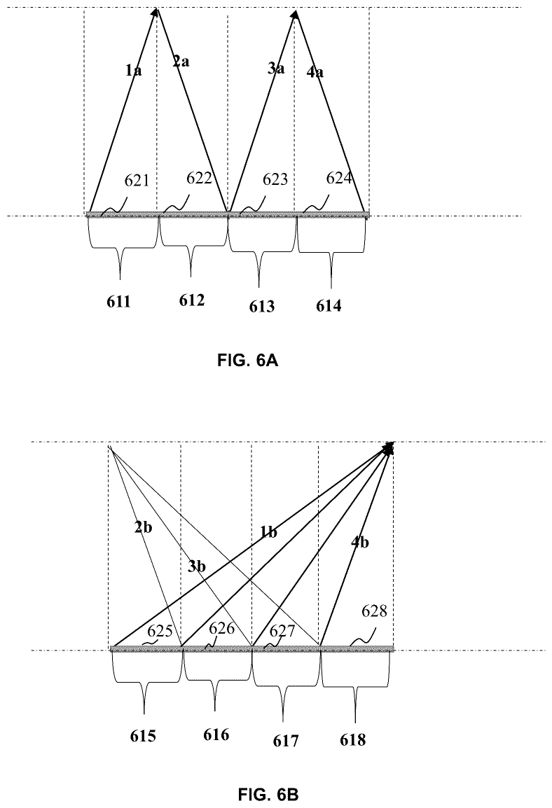

Specifically, for each sub-period of the plurality of sub-periods, the processing device 120 may determine an intermediate image based on a motion vector field of the plurality of motion vector fields and a reconstruction image of the plurality of reconstruction images, the motion vector field and the reconstruction image corresponding to the each sub-period. According to a target weight curve of the plurality of weight curves corresponding to the target sub-period, the processing device 120 may perform a weighted combination on at least two of a plurality of intermediate images corresponding to at least two of the plurality of sub-periods to generate the motion compensation image corresponding to the target sub-period. More descriptions regarding the plurality of weight curves and the determination of the motion compensation image corresponding to the target sub-period may be found elsewhere in the present disclosure (e.g., FIGS. 6A-6B and the description thereof).

Further, the processing device 120 may generate the motion artifact simulation image of the target object by superimposing a plurality of motion compensation images corresponding to the plurality of sub-time periods.

According to the embodiments of the present disclosure, the plurality of motion compensation images corresponding to the plurality of sub-time periods are generated, which is in line with the actual motion of the target object (e.g., coronary artery), thereby improving the efficiency of the motion artifact simulation.

In addition, by the embodiments of the present disclosure, a large number of motion artifact simulation images (i.e., images containing motion artifacts) may be generated. In some embodiments, the large number of motion artifact simulation images may be configured to train a motion artifact removal model, which may improve the performance of the trained motion artifact removal model. The trained motion artifact removal model may be configured to remove or reduce motion artifacts in scanning images of an object in motion, which may improve the imaging quality of the object in motion, thereby improving the accuracy of the diagnosis and treatment of the object. In some embodiments, the motion artifact removal model may include a deep learning model, a machine learning model, or the like, or any combination thereof. For example, the motion artifact removal model may include U-NET, a neural network model, or the like, or any combination thereof.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. In some embodiments, the process 500 may be accomplished with one or more additional operations not described and/or without one or more of the operations discussed above. For example, the process 500 may include an additional transmitting operation in which the processing device 120 may transmit the motion artifact simulation image of the target object to the terminal device 130. As another example, the process 500 may include an additional storing operation in which the processing device 120 may store information and/or data (e.g., the target image, the motion artifact simulation image, the artifact simulation model) associated with the motion artifact simulation in a storage device (e.g., the storage device 150, the storage 220, the storage 390) disclosed elsewhere in the present disclosure and/or an external storage device. However, those variations and modifications do not depart from the scope of the present disclosure.

FIG. 6A-6B are schematic diagrams illustrating exemplary weight curves according to some embodiments of the present disclosure.

As shown in FIG. 6A, each of a plurality of sub-periods may correspond to a weight curve. A sub-period 611 may correspond to a weight curve 1a; a sub-period 612 may correspond to a weight curve 2a; a sub-period 613 may correspond to a weight curve 3a; a sub-period 614 may correspond to a weight curve 4a. For each of the plurality of sub-periods, the processing device 120 may determine an intermediate image based on a motion vector field and a reconstruction image corresponding to the sub-period. For example, the processing device 120 may determine an intermediate image 621 corresponding to the sub-period 611, an intermediate image 622 corresponding to the sub-period 612, an intermediate image 623 corresponding to the sub-period 613, and an intermediate image 624 corresponding to the sub-period 614.

For a target sub-period of the plurality of sub-periods, the processing device 120 may generate a motion compensation image by performing a weighted combination on at least two intermediate images according to a weight curve corresponding to the target sub-period. For example, the processing device 120 may generate a motion compensation image corresponding to the sub-period 611 by performing a weighted combination on the intermediate image 621 and the intermediate image 622 based on the weight curve 1a corresponding to the sub-period 611; the processing device 120 may generate a motion compensation image corresponding to the sub-period 612 by performing a weighted combination on the intermediate image 621, the intermediate image 622, and, the intermediate image 623 based on the weight curve 2a corresponding to the sub-period 612; the processing device 120 may generate a motion compensation image corresponding to the sub-period 613 by performing a weighted combination on the intermediate image 622, the intermediate image 623, and, the intermediate image 624 based on the weight curve 3a corresponding to the sub-period 613; the processing device 120 may generate a motion compensation image corresponding to the sub-period 614 by performing a weighted combination on the intermediate image 623 and the intermediate image 624 based on the weight curve 4a corresponding to the sub-period 614.

Further, the processing device 120 may generate a motion artifact simulation image by superimposing the motion compensation image corresponding to the sub-period 611, the motion compensation image corresponding to the sub-period 612, the motion compensation image corresponding to the sub-period 613, and the motion compensation image corresponding to the sub-period 614. Merely by way of example, the processing device 120 may superimpose the motion compensation images corresponding to the sub-period 611, the sub-period 612, the sub-period 613, and the sub-period 614 by superimposing pixels or voxels in the motion compensation images corresponding to the sub-period 611, the sub-period 612, the sub-period 613, and the sub-period 614.

As shown in FIG. 6B, a sub-period 615 may correspond to a weight curve 1b; a sub-period 616 may correspond to a weight curve 2b; a sub-period 617 may correspond to a weight curve 3b; a sub-period 618 may correspond to a weight curve 4b. The processing device 120 may determine an intermediate image 625 corresponding to the sub-period 615, an intermediate image 626 corresponding to the sub-period 616, an intermediate image 627 corresponding to the sub-period 617, and an intermediate image 628 corresponding to the sub-period 618.

The processing device 120 may generate a motion compensation image corresponding to the sub-period 615 by performing a weighted combination on the intermediate image 625, the intermediate image 626, the intermediate image 627, and the intermediate image 628 based on the weight curve 1b corresponding to the sub-period 615; the processing device 120 may generate a motion compensation image corresponding to the sub-period 616 by performing a weighted combination on the intermediate image 625, the intermediate image 626, the intermediate image 627, and the intermediate image 628 based on the weight curve 2b corresponding to the sub-period 616; the processing device 120 may generate a motion compensation image corresponding to the sub-period 617 by performing a weighted combination on the intermediate image 625, the intermediate image 626, the intermediate image 627, and the intermediate image 628 based on the weight curve 3b corresponding to the sub-period 617; the processing device 120 may generate a motion compensation image corresponding to the sub-period 618 by performing a weighted combination on the intermediate image 625, the intermediate image 626, the intermediate image 627, and the intermediate image 628 based on the weight curve 4b corresponding to the sub-period 618.

Further, the processing device 120 may generate a motion artifact simulation image by superimposing the motion compensation image corresponding to the sub-period 615, the motion compensation image corresponding to the sub-period 616, the motion compensation image corresponding to the sub-period 617, and the motion compensation image corresponding to the sub-period 618.

FIG. 7 is a flowchart illustrating an exemplary process for determining an artifact simulation model according to some embodiments of the present disclosure. In some embodiments, process 700 may be executed by the motion artifact simulation system 100. For example, the process 700 may be implemented as a set of instructions (e.g., an application) stored in a storage device (e.g., the storage device 150, the storage 220, and/or the storage 390) disclosed elsewhere in the present disclosure and/or an external storage device. In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 700.

In 710, the processing device 120 (e.g., the training module 460) (e.g., the interface circuits and/or the processing circuits of the processor 210) may obtain a plurality of training samples.

In some embodiments, at least one of the plurality of training samples may be previously generated and stored in a storage device (e.g., the storage device 150, the storage 220, the storage 390) disclosed elsewhere in the present disclosure and/or an external storage device. The processing device 120 may retrieve the training samples directly from the storage device and/or the external storage device.

In some embodiments, each of the plurality of training samples may include a sample target image including a sample target object and a plurality of sample artifact images of the sample target object. In some embodiments, the sample target image may have no artifact. More descriptions of the sample target image may refer to the description of the target image elsewhere in the present disclosure (e.g., operation 510 in FIG. 5 and the description thereof). More descriptions of the sample target object may refer to the description of the target object elsewhere in the present disclosure (e.g., operation 510 in FIG. 5 and the description thereof). In some embodiments, each of the plurality of sample artifact images of the sample target object may include artifacts of the sample target object. In some embodiments, one of the plurality of sample artifact images of the sample target object may have artifacts different from the other of the plurality of sample artifact images. In some embodiments, the plurality of sample artifact images of the sample target object may be obtained from historical scanning images of the sample target object. In some embodiments, a count of the plurality of sample artifact images of the sample target object may be relatively large.

In 720, the processing device 120 (e.g., the training module 460) (e.g., the processing circuits of the processor 210) may determine an artifact simulation model by performing a plurality of iterative trainings on a preliminary artifact simulation model based on the plurality of training samples.

The preliminary artifact simulation model may include a machine learning model, for example, a neural network model, a deep learning model, etc. Merely by way of example, the neural network model may include a convolutional neural network (CNN), a fully convolutional neural network (FCN), a recursive Neural network (RNN)), a feedforward neural network (FNN), a recurrent neural network (RNN), a long and short-term memory neural network (LSTM), or the like, or any combination thereof. In some embodiments, the preliminary artifact simulation model may include at least one model parameter. A preliminary value of the at least one model parameter may be a default setting of the motion artifact simulation system 100 or may be adjustable under different situations. Taking a CNN model as an example, the at least one model parameter may include a count of convolutional layers, a count of kernels, a kernel size, a stride, a padding of each convolutional layer, or the like, or any combination thereof.

In some embodiments, in each iterative training of the plurality of iterative trainings, the processing device 120 may train the preliminary artifact simulation model (e.g., a preliminary machine learning model) based on one of the plurality of training samples until a termination condition is satisfied. Specifically, in an iteration of an iterative training of the plurality of iterative trainings, the processing device 120 may determine an output image by inputting a training sample of the plurality of training samples into the preliminary artifact simulation model. Further, the processing device 120 may determine whether a termination condition of the iterative training is satisfied by comparing the output image and a plurality of sample artifact images in the training sample. In response to that the termination condition of the iterative training is not satisfied, the processing device 120 may update values of model parameters of the preliminary artifact simulation model and perform a next iteration of the iterative training on the preliminary artifact simulation model with the updated model parameters. In response to that the termination condition of the iterative training is satisfied, the processing device 120 may perform a next iterative training on the preliminary artifact simulation model based on another training sample of the plurality of training samples.

In some embodiments, in an iteration of an iterative training, for each of the plurality of sample artifact images in the training sample, the processing device 120 may determine a degree of difference between the output image and the sample artifact image by comparing the output image and the sample artifact image. The processing device 120 may determine whether a count of sample artifact images with a degree of difference less than a threshold is larger than a first count threshold. The threshold and/or the first count threshold may be determined based on a default value of the motion artifact simulation system 100, manually set by a user (e.g., a doctor, a radiologist) or an operator, or determined by the processing device 120 according to an actual need. In response to that the count of the sample artifact images with a degree of difference less than the threshold is larger than the first count threshold, the processing device 120 may determine that the termination condition of the iterative training is satisfied. In response to that the count of the sample artifact images with a degree of difference less than the threshold is less than or equal to the first count threshold, the processing device 120 may determine that the termination condition of the iterative training is not satisfied.

Additionally or alternatively, the processing device 120 may designate an iteration in which a count of sample artifact images with a degree of difference less than a threshold is larger than a first count threshold as an efficient iteration. In a plurality of iterations that have been completed in an iterative training, the processing device 120 may determine a count of efficient iterations of the plurality of iterations that have been completed. In response to that the count of the efficient iterations is larger than a second count threshold, the processing device 120 may determine that the termination condition of the iterative training is satisfied. The second count threshold may be determined based on a default value of the motion artifact simulation system 100, manually set by a user (e.g., a doctor, a radiologist) or an operator, or determined by the processing device 120 according to an actual need. In response to that the count of the efficient iterations is less than or equal to the second count threshold, the processing device 120 may determine that the termination condition of the iterative training is not satisfied.

In the present disclosure, the artifact simulation model is determined by training the preliminary artifact simulation model based on the plurality of sample artifact images that are obtained from historical scanning images of the sample target object. The historical scanning images of the sample target object can reflect the reality of motion artifacts of the sample target object, accordingly, the motion vector fields determined based on the artifact simulation model conform to the actual motion state of a target object, so that the motion artifact simulation image of the target object generated based on the motion vector fields is closer to the real motion artifact image.

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added or omitted. For example, the processing device 120 may update the artifact simulation model periodically or irregularly based on one or more newly-generated training samples. As another example, the processing device 120 may divide the plurality of training samples into a training set and a test set. The training set may be used to train the model and the test set may be used to determine whether the training process has been completed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or component of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A computer-readable signal medium may include a propagated data signal with computer-readable program code embodied therein, for example, in a baseband or as part of a carrier wave. Such a propagated signal may take any of a variety of forms, including electro-magnetic, optical, or the like, or any suitable combination thereof. A computer-readable signal medium may be any computer-readable medium that is not a computer-readable storage medium and that may communicate, propagate, or transport a program for use by or in connection with an instruction-performing system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
at least one storage device including a set of instructions; and
at least one processor in communication with the at least one storage device, wherein when executing the set of instructions, the at least one processor causes the system to perform operations including:
obtaining a target image including a target object;
determining a plurality of sub-periods of a time period corresponding to the target image;
determining a plurality of motion vector fields of the target object in the plurality of sub-periods, each motion vector field of the plurality of motion vector fields corresponding to one of the plurality of sub-periods;
determining a plurality of reconstruction images of the target object corresponding to the plurality of sub-periods based on projection data of the target image, each reconstruction image of the plurality of reconstruction images corresponding to one of the plurality of sub-periods; and
generating a motion artifact simulation image of the target object based on the plurality of motion vector fields and the plurality of reconstruction images.

2. The system of claim 1, wherein the target image has a quality score higher than a predetermined threshold.

3. The system of claim 1, wherein each motion vector field of the plurality of motion vector fields includes parameters associated with a motion state of the target object.

4. The system of claim 3, wherein the determining the plurality of motion vector fields of the target object in the plurality of sub-periods includes:
determining the plurality of motion vector fields of the target object in the plurality of sub-periods based on the target image, the plurality of sub-periods, and an artifact simulation model.

5. The system of claim 4, wherein the determining the plurality of motion vector fields of the target object in the plurality of sub-periods based on the target image, the plurality of sub-periods, and the artifact simulation model includes:
extracting a centerline of the target object in the target image; and
determining the plurality of motion vector fields of the target object in the plurality of sub-periods based on the centerline of the target object in the target image, the plurality of sub-periods, and the artifact simulation model.

6. The system of claim 4, wherein the artifact simulation model includes a motion function or a machine learning model.

7. The system of claim 6, wherein the motion function includes a random function indicating the motion state of the target object.

8. The system of claim 6, wherein the machine learning model is configured to assign random values to at least a portion of the parameters of the motion vector field.

9. The system of claim 8, wherein the machine learning model is obtained by:
obtaining a plurality of training samples, each of the plurality of training samples including a sample target image of a sample target object and a plurality of sample artifact images of the sample target object; and
determining the machine learning model by performing a plurality of iterative trainings on a preliminary machine learning model based on the plurality of training samples.

10. The system of claim 9, wherein the determining the machine learning model by performing the plurality of iterative trainings on the preliminary machine learning model includes:
in an iteration of an iterative training of the plurality of iterative trainings, determining an output image by inputting a training sample of the plurality of training samples into the preliminary machine learning model;
determining whether a termination condition of the iterative training is satisfied by comparing the output image and a plurality of sample artifact images in the training sample;
in response to that the termination condition of the iterative training is not satisfied, updating values of model parameters of the preliminary machine learning model and performing a next iteration of the iterative training on the preliminary machine learning model with the updated model parameters;
in response to that the termination condition of the iterative training is satisfied, performing a next iterative training on the preliminary machine learning model based on another training sample of the plurality of training samples.

11. The system of claim 1, wherein the determining the plurality of reconstruction images of the target object corresponding to the plurality of sub-periods includes:
obtaining a plurality of projection data sets of the target image, each projection data set of the plurality of projection data sets corresponding to one of the plurality of sub-periods; and
determining the plurality of reconstruction images of the target object corresponding to the plurality of sub-periods based on the plurality of projection data sets of the target image, respectively.

12. The system of claim 1, wherein the generating the motion artifact simulation image of the target object includes:
for a target sub-period of the plurality of sub-time periods, generating a motion compensation image based on at least one of the plurality of motion vector fields and at least one of the plurality of reconstruction images; and
generating the motion artifact simulation image of the target object by superimposing a plurality of motion compensation images corresponding to the plurality of sub-time periods.

13. The system of claim 12, wherein the generating the motion compensation image based on the at least one of the plurality of motion vector fields and the at least one of the plurality of reconstruction images includes:
generating the motion compensation image based on the at least one of the plurality of motion vector fields, the at least one of the plurality of reconstruction images, and at least one of a plurality of weight curves, each of the plurality of weight curves corresponding to one of the plurality of sub-periods.

14. The system of claim 13, wherein the generating the motion compensation image based on the at least one of the plurality of motion vector fields, the at least one of the plurality of reconstruction images, and the at least one of the plurality of weight curves includes:
for each sub-period of the plurality of sub-periods, determining an intermediate image based on a motion vector field of the plurality of motion vector fields and a reconstruction image of the plurality of reconstruction images, the motion vector field and the reconstruction image corresponding to the each sub-period; and
performing a weighted combination on at least two of a plurality of intermediate images corresponding to at least two of the plurality of sub-periods according to a target weight curve of the plurality of weight curves corresponding to the target sub-period.

15. The system of claim 1, wherein the motion artifact simulation image is configured to train a motion artifact removal model.

16. A method implemented on a computing device including at least one processor and at least one storage device, the method comprising:
obtaining a target image including a target object;
determining a plurality of sub-periods of a time period corresponding to the target image;
determining a plurality of motion vector fields of the target object in the plurality of sub-periods, each motion vector field of the plurality of motion vector fields corresponding to one of the plurality of sub-periods;
determining a plurality of reconstruction images of the target object corresponding to the plurality of sub-periods based on projection data of the target image, each reconstruction image of the plurality of reconstruction images corresponding to one of the plurality of sub-periods; and
generating a motion artifact simulation image of the target object based on the plurality of motion vector fields and the plurality of reconstruction images.

17-26. (canceled)

27. The method of claim 16, wherein the generating the motion artifact simulation image of the target object includes:
for a target sub-period of the plurality of sub-time periods, generating a motion compensation image based on at least one of the plurality of motion vector fields and at least one of the plurality of reconstruction images; and
generating the motion artifact simulation image of the target object by superimposing a plurality of motion compensation images corresponding to the plurality of sub-time periods.

28. The method of claim 27, wherein the generating the motion compensation image based on the at least one of the plurality of motion vector fields and the at least one of the plurality of reconstruction images includes:
generating the motion compensation image based on the at least one of the plurality of motion vector fields, the at least one of the plurality of reconstruction images, and at least one of a plurality of weight curves, each of the plurality of weight curves corresponding to one of the plurality of sub-periods.

29. The method of claim 28, wherein the generating the motion compensation image based on the at least one of the plurality of motion vector fields, the at least one of the plurality of reconstruction images, and the at least one of the plurality of weight curves includes:
for each sub-period of the plurality of sub-periods, determining an intermediate image based on a motion vector field of the plurality of motion vector fields and a reconstruction image of the plurality of reconstruction images, the motion vector field and the reconstruction image corresponding to the each sub-period;
performing a weighted combination on at least two of a plurality of intermediate images corresponding to at least two of the plurality of sub-periods according to a target weight curve of the plurality of weight curves corresponding to the target sub-period.

30-31. (canceled)

32. A non-transitory computer readable medium, comprising executable instructions that, when executed by at least one processor, direct the at least one processor to perform a method, the method comprising:
obtaining a target image including a target object;
determining a plurality of sub-periods of a time period corresponding to the target image;
determining a plurality of motion vector fields of the target object in the plurality of sub-periods, each motion vector field of the plurality of motion vector fields corresponding to one of the plurality of sub-periods;
determining a plurality of reconstruction images of the target object corresponding to the plurality of sub-periods based on projection data of the target image, each reconstruction image of the plurality of reconstruction images corresponding to one of the plurality of sub-periods; and
generating a motion artifact simulation image of the target object based on the plurality of motion vector fields and the plurality of reconstruction images.
